(19) United States
(12) Patent Application Publication
(10) Pub. No.: US 2016/0267591 A1
(43) Pub. Date: Sep. 15, 2016

(54) AUTOMATED SECURITIES TRADING ENGINE

(71) Applicant: Matrix Trading Technologies, LLC, New York, NY (US)

(72) Inventor: Louis Feng Liu, New York, NY (US)

(21) Appl. No.: 14/645,919

(22) Filed: Mar. 12, 2015

(51) Int. Cl. G06Q 40/04

(52) U.S. Cl. CPC G06Q 40/04

(57) ABSTRACT

An automated trading engine may include one or more market data adaptors configured to convert market data into an intermediate format, and a formula calculation engine in communication with the market data adaptors that is configured to perform one or more calculations using at least a portion of the intermediate format market data, and generate one or more calculation results. An engine may include a condition comparison module that is configured to compare one or more of the received calculation results to one or more values stored within a field programmable gate array chip to generate one or more comparison result values, and an instruction table. An engine may be configured to use one or more of the comparison result values to identify one or more instruction sets and actions from the instruction table, and generate one or more securities orders based on the identified instruction sets and actions.

### BACKGROUND

Software-based trading systems typically require communications between different parts of the system. For example, data is received from a Network Interface Card (NIC), and an operating system processes a transmission control protocol/Internet protocol (TCP/IP) stack. Data transfer from the NIC to the operating system is commonly performed via a PCI Express (PCIe) interface. Market data handling is commonly performed by software, and order generation software resides in software in the operating system. Once orders are generated, software must format them according to specific market protocols. Afterwards, orders are sent back to the NIC via the PCIe interface, and the operating system processes the TCP/IP stack again to send orders out via the NIC. However, these steps introduce latency to the tick-to-trade path.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. As used herein, the term “comprising” means “including, but not limited to.”

In an embodiment, an automated trading engine may include one or more market data adaptors configured to convert market data into an intermediate format, and a formula calculation engine in communication with the market data adaptors. The formula calculation engine may be configured to perform one or more calculations using at least a portion of the intermediate format market data, and generate one or more calculation results. An automated trading engine may include a condition comparison module in communication with the formula calculation engine, where the condition comparison module is configured to compare one or more of the received calculation results to one or more values stored within a field programmable gate array chip to generate one or more comparison result values. An automated trading engine may include an instruction table comprising one or more indices, one or more instruction sets and one or more actions, where the automated trading engine is configured to use one or more of the comparison result values to identify one or more instruction sets and actions from the instruction table, and generate one or more securities orders based on the identified instruction sets and actions. An automated trading engine may include one or more routing adaptors configured to convert one or more of the generated securities orders into one or more market-specific formats.

In an embodiment, a method of processing market data by an automated trading engine may include receiving, by one or more market data adaptors, market data from one or more market electronic devices, converting the received market data into an intermediate format, performing one or more calculations using at least a portion of the intermediate format market data to generate one or more calculation results, comparing one or more of the calculation results to one or more values stored within a field programmable gate array chip to generate one or more comparison result values, using one or more of the comparison result values to identify one or more instruction sets and actions from an instruction table, generating one or more securities orders based on the identified instruction sets and actions, and converting one or more of the generated securities orders into one or more market-specific formats.

### BRIEF DESCRIPTION OF THE DRAWINGS

FIG. 1A illustrates an example automated trading system according to an embodiment.

FIG. 1B illustrates an example automated trading engine according to an embodiment.

FIG. 2 illustrates a flow chart of an example method of processing market data and generating orders by an automated trading engine according to an embodiment.

FIG. 3 depicts a block diagram of hardware that may be used to contain or implement program instructions.

### DETAILED DESCRIPTION

The following terms shall have, for purposes of this application, the respective meanings set forth below:

An “automated trading engine (ATE)” refers to a hardware-implemented system for automatically receiving and processing one or more securities orders.

A “computing device” or “electronic device” refers to a device that includes a processor and non-transitory, computer-readable memory. The memory may contain programming instructions that, when executed by the processor, cause the computing device to perform one or more operations according to the programming instructions. As used in this description, a “computing device” or “electronic device” may be a single device, or any number of devices having one or more processors that communicate with each other and share data and/or instructions. Examples of computing devices or electronic devices include personal computers, servers, mainframes, gaming systems, televisions, and portable electronic devices such as smartphones, personal digital assistants, cameras, tablet computers, laptop computers, media players and the like.

A “marketplace exchange” or “market” refers to an electronic forum where securities, futures, option contracts, foreign exchanges, commodities and/or the like may be bought and/or sold.

A “securities order” or “order” refers to one or more electronic instructions to buy or sell securities, futures, option contracts, foreign exchanges, commodities and/or the like. A securities order may include one or more data packets or transaction packets pertaining to a trade.

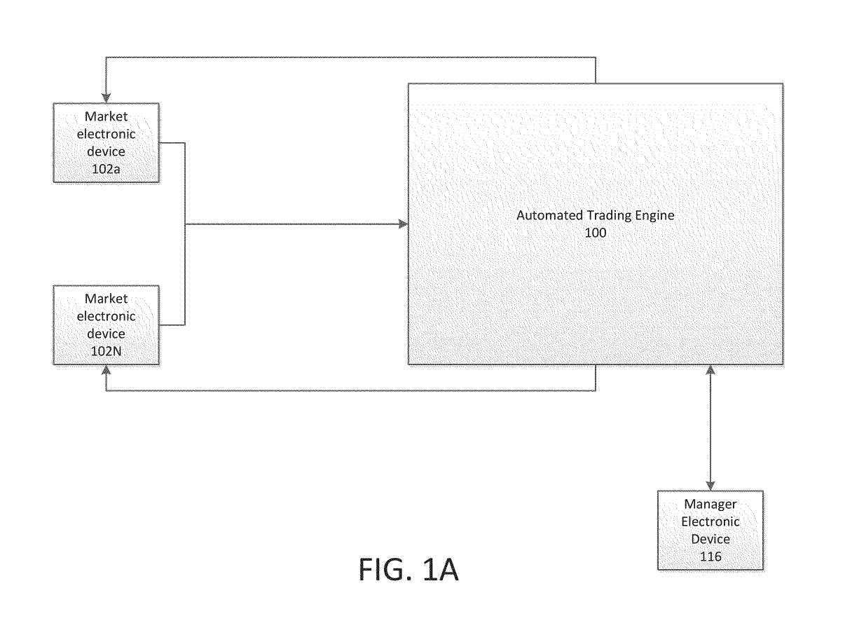

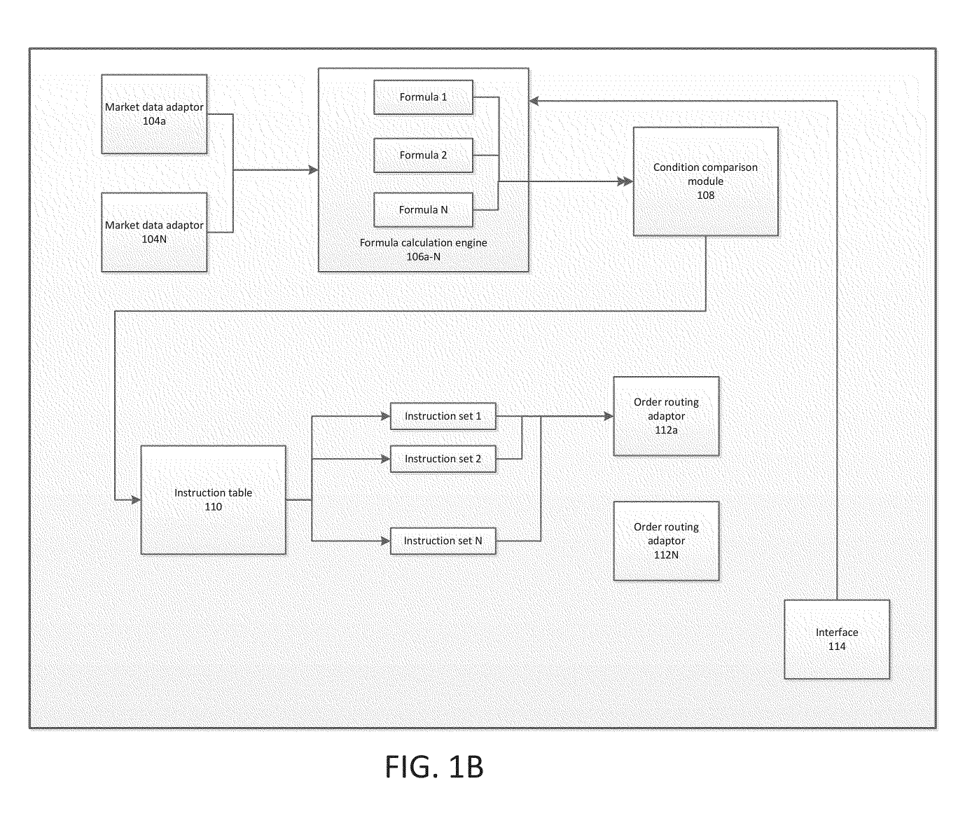

FIG. 1A illustrates an example automated trading system according to an embodiment. As illustrated by FIG. 1A, the system may include one or more market electronic devices 102a-N in communication with an automated trading engine 100. In some embodiments, one or more market electronic devices 102a-N may be electronic devices associated with one or more markets. One or more market electronic devices 102a-N may be in communication with an automated trading engine 100 via a communication channel such as, for example, a local area network (LAN), a wide area network (WAN), a mobile or cellular communication network, an extranet, an intranet, the Internet and/or the like.

In an embodiment, an automated trading engine 100 may be in communication with a manager electronic device 116. A manager electronic device 116 may be configured to configure and/or monitor the hardware of the automated trading engine 100. For instance, a manager electronic device 116 may be an electronic device in communication with the automated trading engine via a PCI Express (PCIe) interface, a network connection, such as, for example, a Transmission Control Protocol/Internet Protocol (TCP/IP) connection, and/or the like. In some embodiments, a manager electronic device 116 may include or may be in communication with a graphical user interface (GUI), an application programming interface (API) and/or the like. For instance, a user may use a GUI, API and/or the like to configure one or more settings or other information associated with an automated trading engine 100.

FIG. 1B illustrates an example automated trading engine 100 according to an embodiment. An automated trading engine 100 may offer a low latent, fully automated trading system that combines a market data handler, a user-configurable formula calculation engine, order generating logic and/or an order routing adaptor. An automated trading engine 100 may be implemented by one or more field programmable gate array (FPGA) chips.

As illustrated by FIG. 1B, an automated trading engine 100 may be in communication with one or more market electronic devices 102a-N. A market electronic device 102a-N may be associated with one or more markets, and may send market data from those markets to the automated trading engine 100. An automated trading engine 100 may include one or more market data adaptors 104a-N. A market data adaptor 104a-N may be configured to receive market data from one or more market electronic devices 102a-N and convert the received data into a different format. For example, an automated trading engine 100 may receive market data from multiple market electronic devices 102a-N that each may have a different format. A market data adaptor 104a-N may convert the received data into a consistent format for use by the automated trading engine 100. In certain embodiments, a market data adaptor 104a-N may be configured to handle one or more binary protocols and/or Financial Information eXchange protocol-based markets.

As illustrated by FIG. 1B, an automated trading engine 100 may include one or more formula calculation engines 106a-N. A formula calculation engine 106a-N may include hardware configured to perform one or more calculations pursuant to one or more formulas. In certain embodiments, one or more parameters of one or more formulas may be user-configurable.

An automated trading engine 100 may include a condition comparison module 108. A condition comparison module 108 may perform one or more comparisons on the output of one or more formula calculation engines 106a-N.

An automated trading engine may include an instruction table 110. An instruction table 110 may include one or more instructions to buy or sell securities. An instructions table 110 may generate one or more orders. An automated trading engine may include one or more order routing adaptors 112a-N, which may convert one or more orders into market-specific formats. An automated trading engine 100 may be in communication with one or more market electronic devices 102a-N to which one or more converted orders may be sent.

An automated trading engine 100 may include an interface 114 according to an embodiment. An automated trading engine 100 may communicate with a manager 116 via the interface 114. In certain embodiments, the interface 114 may be a PCIe interface, a TCP/IP interface, and/or the like. The interface 114 may serve as an interface through which the hardware of the automated trading engine 100 may be controlled, managed, monitored and/or the like. For example, the interface 114 may allow users and/or a manager to control, manage and/or monitor the automated trading device's hardware such as, for example, one or more FPGA chips.

For example, a manager electronic device may send one or more instructions to the automated trading engine. The instructions may include one or more instructions to change, adjust and/or modify one or more settings of the automated trading engine. For instance, the instructions may include updated values for one or more user-defined parameters. The automated trading engine may receive the instructions, and may change, adjust and/or modify one or more of its settings in accordance with the received instructions.

In certain embodiments, the automated trading engine 100 may include one or more hardware components such as, for example, one or more FPGA chips. For example, one or more of market data adaptors 104a-N, formula calculation engine 106a-N, condition comparison module 108, instruction table 110, order routing adaptors 112a-N and/or interface 114 may be implemented using one or more FPGA chips.

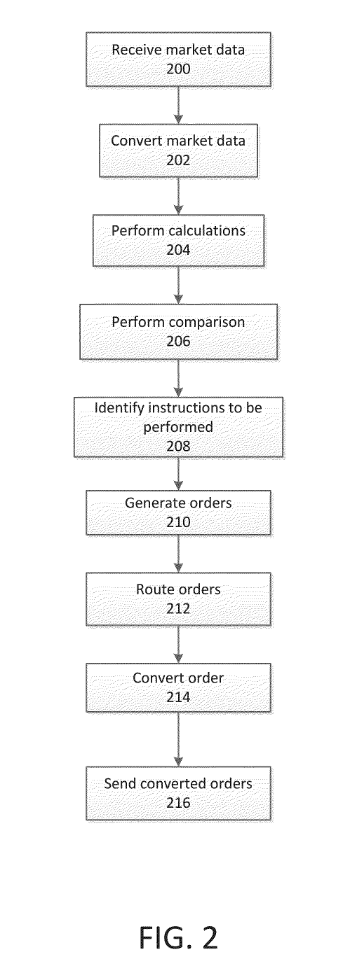

FIG. 2 illustrates a flow chart of an example method of processing market data by an automated trading engine according to an embodiment. As illustrated by FIG. 2, market data may be received 200 by an automated trading engine. For example, market data may be received 200 from one or more market electronic devices by a market data adaptor. Market data may be information representing an offer to buy or sell a securities order. For example, market data may include information pertaining to one or more securities to be bought or sold such as, for example, symbol, price, quantity, side, order type, session related data and/or the like.

In an embodiment, an automated trading engine may convert 202 the received market data into a different format. An automated trading engine may receive market data associated with different markets that may have different formats. As such, the automated trading engine may convert 202 the received market data into a different format to be processed by the automated trading engine. For example, an automated trading engine may convert 202 market data into an internal format for processing. In an embodiment, one or more market data adaptors of the automated trading engine may convert 202 the market data into a different format.

In some embodiments, an automated trading engine may store the converted market data along with an identifier of the market from which the market data was received. This information may be stored in an on-chip memory located inside an FPGA of the automated trading engine. In another embodiment, this information may be stored in off-chip memory that may directly connect to or communicate with an FPGA of the automated trading system.

In an embodiment, the received market data may include an identifier of the market from which it was sent. In another embodiment, an automated trading engine may generate an identifier associated with the market from which market data is received. For instance, an automated trading engine may maintain a list, database, matrix or other data identifying the market electronic devices and their associated markets. An automated trading engine may generate an identifier associated with a market based on the market electronic device from which the market data is received.

In certain embodiments, the automated trading engine may use the converted market data to build level 1, level 2 and/or level 3 order books. A level 1 book may include the lowest ask and highest bid information available. A level 2 book may include bid and/or ask information for one or more market participant in one or more securities. For example, level 2 information may include a highest bid and a lowest ask for one or more participants. A level 3 book may include order specific information on one or more price levels. In an embodiment, an automated trading engine may build one or more order books by storing information associated with one or more books in an on-chip memory located inside an FPGA. In another embodiment, an automated trading engine may store information associated with one or more books in off-chip memory that may directly connect to or communicate with an FPGA.

In an embodiment, the converted market data and/or information from the order books may be used as input by one or more formula calculation engines to perform 204 one or more calculations using the converted market data. A formula calculation engine may contain hardware, such as, for example, one or more FPGAs, configured to perform specific calculations with accelerated performance and minimum latency. For instance, one or more calculations or one or more parameters associated with one or more calculations may be stored in an on-chip memory located inside an FPGA of an automated trading engine. In another embodiment, an automated trading engine may store information associated with calculations or parameters in off-chip memory that may directly connect to or communicate with an FPGA.

In some embodiments, formula calculations may be performed in parallel. In certain embodiments, one or more parameters of these formulas may be configurable by a user. For example, one or more parameters may be configured by a user via an application program interface, a graphical user interface and/or the like that is in communication with an interface of an automated trading engine. An interface of an automated trading device may receive a value for one or more configurable parameters, and may cause the value of the parameter to be changed in the formula calculation engine. For instance, an interface may send one or more instructions to the formula calculation engine that causes the value of the parameter to be changed.

As an example, a formula calculation engine may perform 204 the calculation Σᵢ₌₁^{N}wᵢxᵢ+C to determine a difference between a current market index and a calculated index value, where:
N−1 represents the number of stocks in the stock index;
xᵢ is the price of stock i in the index calculation;
x_{N} is the current market index value;
wᵢ represents the weight of the stock price in the index calculation; all wᵢ's where i has a value between 0 and N−1 may be negative, and w_{N} may be equal to 1; and
C represents a threshold value.

In an embodiment, by configuring parameter C and comparing the value of the formula Σᵢ₌₁^{N}wᵢxᵢ+C to a value of ‘0’, an automated trading engine can determine a difference between the current market index value and the calculated index value based on current stock prices. Based on the result of the comparison, the system may determine which of the stock combination or the stock index is too expensive relative to the other. The value of parameter C may represent an indication of how expensive the stock combination or the stock index is to the other.

In some embodiments, the weight value may be configurable by a user. For instance, a user may specify or modify the weight value for one or more securities using a GUI, API and/or the like that is in communication with an interface of an automated trading engine. An interface of an automated trading device may receive a value for a weight value, and may cause the weight value to be changed in the formula calculation engine. For instance, an interface may send one or more instructions to the formula calculation engine that causes the value of the weight value to be changed.

In certain embodiments, the results of the formula calculation engine may be provided as input to a condition comparison module. A condition comparison module may compare 206 at least a portion of the results of the formula calculation engine(s) to one or more values. For example, a condition comparison value may be configured to be ‘0.’ The result of a formula may be compared to the value ‘0’. If the result is greater than or equal to ‘0’, a comparison result may be assigned a value of ‘1’. Otherwise, a comparison result may be assigned a value of ‘0’. In an embodiment, the value to which a result of the formula calculation engine is compared may be a value that is pre-configured or set by an automated trading engine. For example, a user may specify such a value using a GUI, API and/or the like that is in communication with an interface of an automated trading engine. An interface of an automated trading device may receive the value, and may cause the value to be assigned by the formula calculation engine. For instance, an interface may send one or more instructions to the formula calculation engine that causes the value to be set or configured.

In an embodiment, a comparison performed by a condition comparison module may result in a Boolean value. For example, a comparison may result in a “0” if the result from the formula calculation engine does not match a comparison condition with a corresponding value, or a “1” if the result from the formula calculation engine matches a comparison condition with a corresponding value. In various embodiments, one or more comparison condition values may be stored in an on-chip memory located inside an FPGA of an automated trading engine. In another embodiment, an automated trading engine may store one or more comparison condition values in off-chip memory that may directly connect to or communicate with an FPGA.

In an embodiment, an automated trading engine may map multiple comparisons to an N-bit binary code, where N is the number of comparisons. The N-bit binary code may represent 2^{N} number of different values. For instance, an automated trading engine may perform five comparisons which may yield the comparison result values illustrated in Table 1. An automated trading engine may map the comparison result values illustrated in Table 1 to the binary code 01101.

TABLE 1

| | Compar- | Compar- | Compar- | Compar- | Compar- |
|---|---|---|---|---|---|
| | ison 1 | ison 2 | ison 3 | ison 4 | ison 5 |
| Comparison | 0 | 1 | 1 | 0 | 1 |
| Result Value | | | | | |

In various embodiments, an automated trading engine may use the output of the condition comparison module to identify 208 one or more instructions sets to be performed. For example, an instruction table may use the output of the condition comparison module as an index to determine one or more instructions sets. In an embodiment, an instruction table may be stored in an on-chip memory located inside an FPGA of an automated trading engine. In another embodiment, an automated trading engine may store an instruction table in off-chip memory that may directly connect to or communicate with an FPGA. Table 2 illustrates an example instruction table according to an embodiment.

TABLE 2

| Binary Code | Instruction Set | Result |
|---|---|---|
| Binary Code 1 | Instruction Set 1 | Triggered |
| Binary Code 2 | Instruction Set 2 | Not Triggered |
| Binary Code 3 | Instruction Set 3 | Triggered |
| . . . | . . . | |
| Binary Code N | Instruction Set N | Triggered |

As illustrated by Table 2, an automated trading engine may use the output of the condition comparison module to identify 208 a particular instruction set. For instance, a binary output may indicate whether a particular instruction set is to be triggered or not triggered. For example, if Binary Code 1 is the result of the condition comparison module, then the automated trading engine may locate the binary code in the instruction table to identify 208 that Instruction Set 1 is to be triggered. In some embodiments, an automated trading engine may analyze the value of each bit of an N-bit binary code to identify a particular instruction set. In other embodiments, an automated trading engine may analyze the value of one or more bits of an N-bit binary code to identify a particular instruction set. For instance, a binary code with a leading “0” bit may trigger the same instruction set regardless of the values of the following bits. Additional and/or alternate bit configurations may be used within the scope of this disclosure.

For example, a comparison result of ‘0’ may indicate that stock index is too expensive relative to stocks combination. An automated trading engine may map the comparison result “0” to the first bit of an N-bit binary code. An automated trading engine may identify an instruction set corresponding to the index having a first bit equal to “0.” For example, an automated trading engine may identify an instruction set that includes one or more instructions to buy the stock combination at a certain price, for a certain quantity of units and/or the like.

As another example, an automated trading engine may perform the above-identified calculation Σᵢ₌₁^{N}wᵢxᵢ+C with respect to call-put parity. Under a call-put parity theory, the price of a call option and the price of a put option should have a fixed relationship based on current market conditions such as, for example, interest rate, current time, dividends and/or the like. An automated trading engine may evaluate a relationship between a call option and a put option by performing the above-identified calculation and comparing the result to ‘0’ to see which option is too expensive. As explained above, the resulting comparison result value may then be used to identify an instruction set to be triggered.

Although the calculation Σᵢ₌₁^{N}wᵢxᵢ+C is discussed in this disclosure with respect to index arbitrage and call-put parity, it is understood that this calculation may be used in other securities related situations according to this disclosure. It is also understood that an automated trading engine may perform one or more other calculations within the scope of this disclosure.

In an embodiment, the automated trading engine may use the identified instruction set to generate 210 one or more orders, each associated with one or more buy/sell instructions. An order may include instructions to buy and/or sell a particular quantity of a particular security at a certain price by a certain market, and/or the like. For instance, an identified instruction set may include one or more parameters associated with a buy or sell instruction such as, for example, quantity to buy or sell, price at which to buy or sell, a date or time at which to buy or sell and/or the like. An automated trading engine may generate 210 one or more orders by compiling one or more of these parameters into instructions.

In an embodiment, an order may be routed 212 to one or more order routing adaptors. An order routing adaptor may convert 214 one or more orders into one or more market-specific formats. For example, an order routing adaptor may access the identifier associated with the market data that corresponds to the order to determine the market from which the market data was received. The order routing adaptor may convert 214 one or more orders into a format that corresponds to the determined market.

The order routing adaptor may send 216 one or more of the converted buy/sell orders to one or more market electronic devices associated with the appropriate market. A market electronic device may receive an order, and may execute the buy/sell instructions associated with the order.

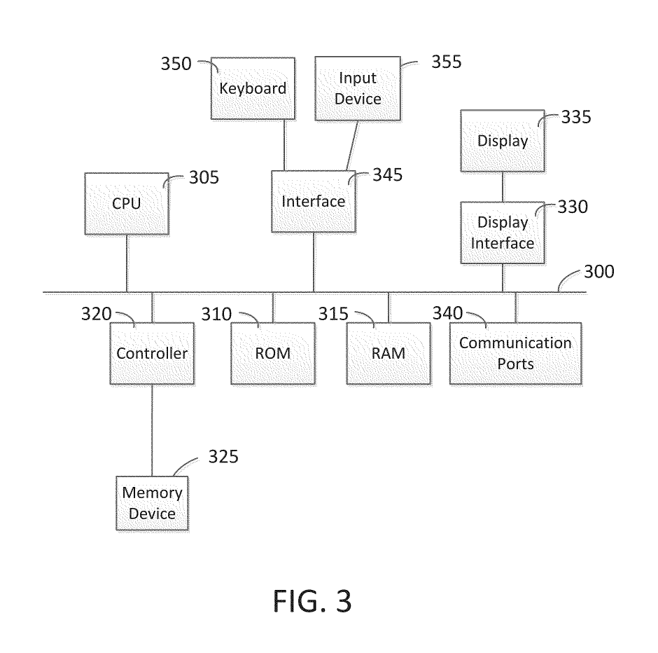

FIG. 3 depicts a block diagram of hardware for one or more electronic devices, such as, for example, market electronic devices or manager electronic devices, that may be used to contain or implement program instructions. A bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is an example of a production device, computing device or processor as such terms are used within this disclosure. Read only memory (ROM) 310 and random access memory (RAM) 315 constitute examples of non-transitory computer-readable storage media.

A controller 320 interfaces with one or more optional non-transitory computer-readable storage media 325 to the system bus 300. These storage media 325 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 310 and/or the RAM 315. Optionally, the program instructions may be stored on a tangible, non-transitory computer-readable medium such as a compact disk, a digital disk, flash memory, a memory card, a USB drive, an optical disc storage medium and/or other recording medium.

An optional display interface 330 may permit information from the bus 300 to be displayed on the display 335 in audio, visual, graphic or alphanumeric format. Communication with external devices, such as a printing device, may occur using various communication ports 340. A communication port 340 may be attached to a communications network, such as the Internet or an intranet.

The hardware may also include an interface 345 which allows for receipt of data from input devices such as a keyboard 350 or other input device 355 such as a mouse, a joystick, a touch screen, a remote control, a pointing device, a video input device and/or an audio input device.

It will be appreciated that the various above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. An automated trading engine comprising:
one or more market data adaptors configured to convert market data into an intermediate format;
a formula calculation engine in communication with the market data adaptors, wherein the formula calculation engine is configured to:
perform one or more calculations using at least a portion of the intermediate format market data, and
generate one or more calculation results;
a condition comparison module in communication with the formula calculation engine, wherein the condition comparison module is configured to compare one or more of the received calculation results to one or more values stored within a field programmable gate array chip to generate one or more comparison result values;
an instruction table comprising one or more indices, one or more instruction sets and one or more actions, wherein the automated trading engine is configured to:
use one or more of the comparison result values to identify one or more instruction sets and actions from the instruction table, and
generate one or more securities orders based on the identified instruction sets and actions; and
one or more routing adaptors configured to convert one or more of the generated securities orders into one or more market-specific formats.

2. The automated trading engine of claim 1, wherein one or more of the following are implemented by one or more field programmable gate array chips:
the market data adaptors;
the formula calculation engine;
the condition comparison module;
the instruction table; and
the routing adaptors.

3. The automated trading engine of claim 1, wherein the automated trading engine is in communication with one more market electronic devices, each associated with one or more markets, wherein the automated trading engine is configured to receive the market data from one or more of the market electronic devices.

4. The automated trading engine of claim 1, wherein the formula calculation engine is further configured to perform one or more calculations using one or more user-defined parameters.

5. The automated trading engine of claim 1, further configured to map one or more comparison result values to a binary code, wherein a length of the binary code equals a number of comparisons performed by the condition comparison module.

6. The automated trading engine of claim 5, wherein the automated trading engine is further configured to:
for each binary code, compare one or more bits of the binary code to one or more of the indices in the instruction table to identify a corresponding instruction set and actions; and
perform the identified action using the identified instruction set.

7. The automated trading engine of claim 1, further configured to send one or more of the market-specific format securities orders to one or more market electronic devices that are each associated with one or more markets.

8. The automated trading engine of claim 1, wherein the automated trading engine is in communication with a manager electronic device, wherein the automated trading engine is further configured to receive one or more instructions from the manager electronic device and change one or more settings of the automated trading engine in response to receiving the instructions.

9. A method of processing market data by an automated trading engine, the method comprising:
receiving, by one or more market data adaptors, market data from one or more market electronic devices;
converting the received market data into an intermediate format;
performing one or more calculations using at least a portion of the intermediate format market data to generate one or more calculation results;
comparing one or more of the calculation results to one or more values stored within a field programmable gate array chip to generate one or more comparison result values;
using one or more of the comparison result values to identify one or more instruction sets and actions from an instruction table;
generating one or more securities orders based on the identified instruction sets and actions; and
converting one or more of the generated securities orders into one or more market-specific formats.

10. The method of claim 9, wherein performing one or more calculations comprises performing one or more calculations using one or more user-defined parameters.

11. The method of claim 9, further comprising mapping one or more comparison result values to a binary code, wherein a length of the binary code equals a number of comparisons performed by the condition comparison module.

12. The method of claim 11, further comprising
for each binary code, comparing one or more bits of the binary code to one or more of the indices in the instruction table to identify a corresponding instruction set and actions; and
performing the identified action using the identified instruction set.

13. The method of claim 9, further comprising sending one or more of the market-specific format securities orders to one or more market electronic devices that are each associated with one or more markets.

14. The method of claim 9, further comprising:
receiving one or more instructions from a manager electronic device; and
changing one or more settings of an automated trading engine in response to receiving the instructions.
